(19) United States
(12) Patent Application Publication
(10) Pub. No.: US 2010/0141748 A1
(43) Pub. Date: Jun. 10, 2010

(54) IMAGE CAPTURING APPARATUS

(75) Inventor: Hiroshi YAMAGUCHI, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/633,568

(22) Filed: Dec. 8, 2009

(30) Foreign Application Priority Data
Dec. 9, 2008 (JP) 2008-313673

(51) Int. Cl. H04N 7/18; H04N 5/217; H04N 5/222

(52) U.S. Cl. 348/68; 348/241; 348/E05.078; 348/370; 348/E05.022; 348/E07.085

(57) ABSTRACT

Provided is an image capturing apparatus for capturing a fluorescent light image from a subject irradiated with first excitation light or second excitation light, including: a first filter that transmits remaining light of a first wavelength band after filtering out, from the light of the first wavelength band, a wavelength band of the first excitation light; a first light receiving element that receives the light transmitted through the first filter; a second filter that transmits remaining light of a second wavelength band after filtering out, from the light of the second wavelength band, a wavelength band of the second excitation light; and a second light receiving element that receives the light transmitted through the second filter.

### CROSS REFERENCE TO RELATED APPLICATIONS

The present application claims priority from a Japanese Patent Application No. 2008-313673 filed on Dec. 9, 2008, the contents of which are incorporated herein by reference.

### BACKGROUND

1. Technical Field

The present invention relates to an image 12 a subject irradiated with first excitation light or second excitation light.

2. Description of the Related Art

Japanese Patent Application Publication No. 2003-102680 (Patent Document No. 1) describes providing an excitation light cutting filter in front of an image capturing element. Another technology is also known to capture a fluorescent light image by providing, in front of an image capturing element, a rotation filter having two filters transmitting two rays of fluorescent light.

In Patent Document No. 1, an excitation light cutting filter transmitting the wavelength band of 470-700 nm is provided in front of the image capturing element, and so a blue light image cannot be captured in normal light image capturing, thereby compromising the accuracy of the color image quality. Moreover, this technique cannot cut the other excitation light.

### SUMMARY

According to an aspect of the innovations herein, provided is an image capturing apparatus for capturing a fluorescent light image from a subject irradiated with first excitation light or second excitation light, including: a first filter that transmits remaining light of a first wavelength band after filtering out, from the light of the first wavelength band, a wavelength band of the first excitation light; a first light receiving element that receives the light transmitted through the first filter; a second filter that transmits remaining light of a second wavelength band after filtering out, from the light of the second wavelength band, a wavelength band of the second excitation light; and a second light receiving element that receives the light transmitted through the second filter.

The image capturing apparatus may further include a third filter that transmits light of a third wavelength band that is different from the first wavelength band and the second wavelength band; and a third light receiving element that receives light transmitted through the third filter, where each of the first wavelength band, the second wavelength band, and the third wavelength band is a red wavelength band, a green wavelength band, or a blue wavelength band.

The image capturing apparatus may have a) a normal image capturing mode for capturing a visible light image of the subject by irradiating the subject with visible light belonging to the first wavelength band, the second wavelength band, and the third wavelength band, and b) a fluorescent light image capturing mode for capturing the fluorescent light image of the subject by irradiating the subject with the first excitation light or the second excitation light, and the image capturing apparatus may further include: a visible light image generating section that generates the visible light image of the subject, from light received by the first light receiving element, light received by the second light receiving element, and light received by the third light receiving element in the normal image capturing mode; and a fluorescent light image generating section that generates the fluorescent light image of the subject, from light received by at least one of the first light receiving element, the second light receiving element, and the third light receiving element, in the fluorescent light image capturing mode.

At least one of the first filter, the second filter, and the third filter may transmit fluorescent light from the subject irradiated with the first excitation light.

At least one of the first filter, the second filter, and the third filter may transmit fluorescent light from the subject irradiated with the second excitation light.

At least one of the first light receiving element, the second light receiving element, and the third light receiving element that receives the fluorescent light from the subject may be more sensitive than the light receiving elements not receiving the fluorescent light from the subject.

The image capturing apparatus may further include: an image capturing element in which first light receiving elements, second light receiving elements, and third light receiving elements are arranged in a plane; and an image capturing element driver that drives the image capturing element, where the image capturing element driver adds up charge accumulated in a plurality of light receiving elements that receive the fluorescent light from the subject before reading the accumulated charge, the plurality of light receiving elements being among the first light receiving elements, the second light receiving elements, and the third light receiving elements.

The image capturing apparatus may include a light splitter that splits the fluorescent light from the subject into three, and supplies the split light respectively to the first filter, the second filter, and the third filter; a first image capturing element in which first light receiving elements are arranged to receive the light transmitted through the first filter; a second image capturing element in which second light receiving elements are arranged to receive the light transmitted through the second filter; a third image capturing element in which third light receiving elements are arranged to receive the light transmitted through the third filter; and an image capturing element driver that drives the first image capturing element, the second image capturing element, and the third image capturing element, where the image capturing element driver adds up charge accumulated in a plurality of light receiving elements that receive the fluorescent light from the subject, before reading the accumulated charge, the plurality of light receiving elements being among the first light receiving elements, the second light receiving elements, and the third light receiving elements.

The summary of the invention does not necessarily describe all necessary features of the present invention. The present invention may also be a sub-combination of the features described above.

### BRIEF DESCRIPTION OF THE DRAWINGS

FIG. 1 shows an image capturing apparatus 100 according to the present embodiment.

FIG. 2 shows an example of a rotation filter 109.

FIG. 3 shows an example of a correspondence between a light source 108 and the rotation filter 109.

FIG. 4 shows an example of a correspondence between a color filter 170 and an image capturing element 160.

FIG. 5A shows an example of excitation light and wavelengths of fluorescent light excited by the excitation light, and FIG. 5B shows an example of a transmission characteristic of an R color filter 171, a G color filter 172, and a B color filter 173.

FIG. 6 shows an example of an image capturing section 112 of an image capturing apparatus 100 according to the present modification example 1.

### DESCRIPTION OF EXEMPLARY EMBODIMENTS

The invention will now be described based on the preferred embodiments, which do not intend to limit the scope of the present invention, but exemplify the invention. All of the features and the combinations thereof described in the embodiment are not necessarily essential to the invention.

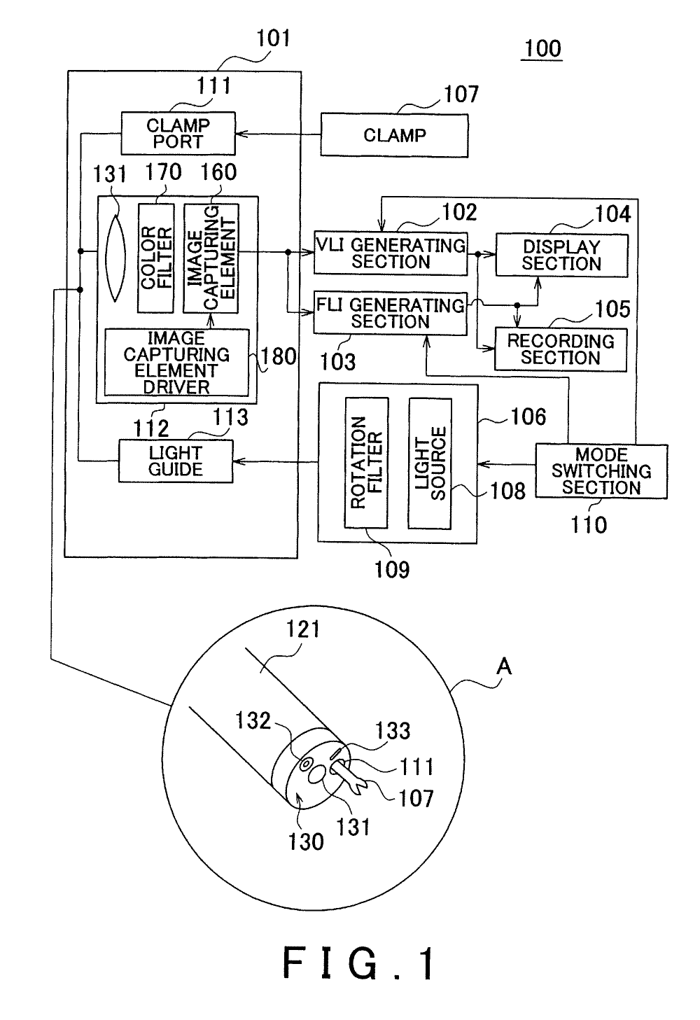

FIG. 1 shows an image capturing apparatus 100 according to the present embodiment. In the present embodiment, the image capturing apparatus 100 is explained as an endoscope system. The image capturing apparatus 100 includes an endoscope 101, a visible light image (VLI) generating section 102, a fluorescent light image (FLI) generating section 103, a display section 104, a recording section 105, an irradiating section 106, a clamp 107, and a mode switching section 110. Note that the section A in FIG. 1 is an enlarged view of a tip 121 of the endoscope 101.

The endoscope 101 includes a clamp port 111, an image capturing section 112, and a light guide 113. The tip 121 of the endoscope 101 has, on its end surface 130, a lens 131 as a part of the image capturing section 112. The tip 121 also has an outlet 132 as a part of the light guide 113 at its end surface 130.

The irradiating section 106 irradiates a subject with light. The irradiating section 106 irradiates a subject with at least two or more rays of excitation light having different wavelengths from each other. The irradiating section 106 irradiates a subject with white light. The white light is an example of visible light in a red wavelength band, a green wavelength band, and a blue wavelength band. The irradiating section 106 includes a light source 108 and a rotation filter 109. The light source 108 emits white light. The light source 108 may be an electric bulb or an LED. The rotation filter 109 includes a filter transmitting white light, and a plurality of filters transmitting two or more rays of excitation light having different wavelengths from each other. The irradiating section 106 switches the wavelength band of light to be irradiated by rotating this rotation filter 109, thereby irradiating the subject with white light and excitation light. An arrangement is possible in which the tip 121 of the endoscope 101 be provided with an LED emitting white light and a plurality of LEDs emitting rays of excitation light having different wavelengths from each other, so as to irradiate the subject with light emission from the LEDs.

The light guide 113 is made up of optical fibers, for example. The light guide 113 guides light emitted from the irradiating section 106 towards the tip 121 of the endoscope 101. The light emitted from the irradiating section 106 is guided through the light guide 113 to be outputted from the outlet 132 on the end surface 130 and irradiate the subject.

The image capturing section 112 includes a lens 131, a color filter 170, an image capturing element 160, and an image capturing element driver 180. The color filter 170 includes an R color filter transmitting light of a red wavelength band, a G color filter transmitting light of a green wavelength band, and a B color filter transmitting light of a blue wavelength band. The image capturing element 160 includes an R light receiving element receiving light transmitted through the R color filter, a G light receiving element receiving light transmitted through the G color filter, and a B light receiving element receiving light transmitted through the B color filter. The image capturing element driver 180 reads the charge accumulated in the light receiving element of the image capturing element 160. When reading, the image capturing element driver 180 may add together the charge accumulated in the light receiving elements of the image capturing element 160. In other words, the image capturing element driver 180 may perform binning in reading the charge. The image capturing section 112 includes an AD converter or the like not shown in the drawing, and the AD converter converts image data read from the image capturing element 160, into image data of a digital signal. This image capturing element driver 180 is controlled by an information processing apparatus such as a CPU. The information processing apparatus may be provided in the image capturing section 112, or in the image capturing apparatus 100.

A functional block including a visible light image generating section 102 and a fluorescent light image generating section 103 is an example of the image generating section generating an image of a subject from light received by one or more of an R light receiving element, a G light receiving element, and a B light receiving element respectively of the image capturing element 160. The visible light image generating section 102 generates a visible light image of a subject from light respectively received by the R light receiving element, the G light receiving element, and the B light receiving element of the image capturing element 160. That is, the visible light image of the subject is generated from the charge accumulated in each light receiving element. The fluorescent light image generating section 103 generates a fluorescent light image of a subject from light received by at least one of the R light receiving element, the G light receiving element, and the B light receiving element. Concretely, the fluorescent light image generating section 103 generates the fluorescent light image of the subject, from the light received by the R light receiving element, the G light receiving element, or the B light receiving element. That is, the fluorescent light image of the subject is generated from the charge accumulated in the R light receiving element, the G light receiving element, or the B light receiving element. The visible light image generating section 102 and the fluorescent light image generating section 103 may be realized by an information processing apparatus such as a CPU, or by electronic circuitry or electric circuitry.

The display section 104 displays a visible light image generated by the visible light image generating section 102. The display section 104 displays a fluorescent light image generated by the fluorescent light image generating section 103. The display section 104 may include a display such as a liquid crystal display, an organic EL display, and a plasma display, and a display control section controlling the display. The display control section may be realized by an information processing apparatus such as a CPU. The recording section 105 records a visible light image generated by the visible light image generating section 102. The recording section 105 further records a fluorescent light image generated by the fluorescent light image generating section 103. The recording section 105 may include a recording medium such as a flash memory and a recording control section recording an image to the recording medium. The recording control section may be realized by an information processing apparatus such as a CPU.

The mode switching section 110 switches between a normal image capturing mode for capturing a visible light image of a subject by irradiating the subject with white light, and a fluorescent light image capturing mode for capturing a fluorescent light image of a subject by irradiating the subject with excitation light. The mode switching section 110 may switch between the modes according to a user instruction. The mode switching section 110 may be realized by an information processing apparatus such as a CPU. When the mode switching section 110 switches to the normal image capturing mode, the irradiating section 106 irradiates a subject with white light. Then, the visible light image generating section 102 generates a visible light image from the charge accumulated in each light receiving element having received the returned light. When the mode switching section 110 switches to the fluorescent light image capturing mode, the irradiating section 106 irradiates a subject with excitation light. The fluorescent light image generating section 103 generates a fluorescent light image from the charge accumulated in the R light receiving element, the G light receiving element, or the B light receiving element having received the fluorescent light excited by the excitation light.

The clamp 107 is inserted to the clamp port 111. The clamp port 111 guides the clamp 107 towards the tip 121. Note that the form of the tip of the clamp 107 may be varied. Moreover, a various type of devices, other than the clamp 107, may be inserted to the clamp port 111, for treating a living body. A nozzle 133 delivers water or air to outside.

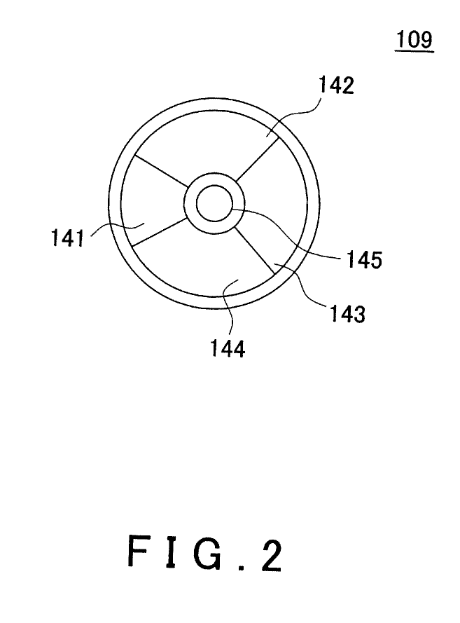

FIG. 2 shows an example of a rotation filter 109. The rotation filter 109 includes a filter 141, a filter 142, a filter 143, and a filter 144. In the rotation filter 109, the filter 141, the filter 142, the filter 143, and the filter 144 are arranged along a circle. A shaft 145 being the center of rotation is provided in the center of the rotation filter 109.

The filter 141 transmits white light. The filter 141 may transmit the light emitted from the light source 108 as it is. The filter 141 may be replaced by a hollow. The filter 142 transmits excitation light. Here, the excitation light transmitted through the filter 142 excites flavin adenine nucleotide (FAD) that is a self fluorescent substance inherently contained in the living tissue. That is, the filter 142 transmits light of a peak wavelength of about 460 nm. The filter 143 transmits excitation light. The excitation light transmitted through the filter 143 has a wavelength band different from the wavelength band of light transmitted through the filter 142. Here, the excitation light transmitted through the filter 143 excites the fluorochrome of Alexa Fluor (registered trademark) 555. That is, the filter 143 transmits light of a peak wavelength of about 555 nm. The filter 144 transmits excitation light. The excitation light transmitted through the filter 144 has a wavelength band different from the wavelength bands of light respectively transmitted through the filter 142 and the filter 143. Here, the excitation light transmitted through the filter 144 excites the fluorochrome of Alexa Fluor (registered trademark) 647. That is, the filter 144 transmits light of a peak wavelength of about 647 nm.

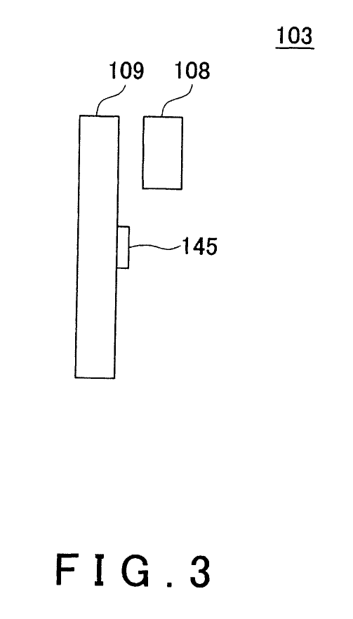

FIG. 3 shows an example of a correspondence between the light source 108 and the rotation filter 109. The irradiating section 106 rotates the rotation filter 109 with the shaft 145 being the axis of rotation, thereby setting any of the filters 141, 142, 143, and 144 on the optical path of light emitted from the light source 108. The irradiating section 106 rotates the rotation filter 109, to emit white light and rays of excitation light having different wavelengths from each other. For example, for emitting white light, the irradiating section 106 emits light by setting the filter 141 on the optical path. For emitting exciting light for exciting FAD, the filter 142 is set on the optical path. For emitting exciting light for exciting Alexa Fluor (registered trademark) 555, the filter 143 is set on the optical path. For emitting exciting light for exciting Alexa Fluor (registered trademark) 647, the filter 144 is set on the optical path. Note that the irradiating section 106 has an irradiation control section for controlling the light source 108 and the rotation filter 109. The irradiation control section controls the light emission of the light source 108 and the rotation of the rotation filter 109. The irradiation control section may be realized by an information processing apparatus such as a CPU.

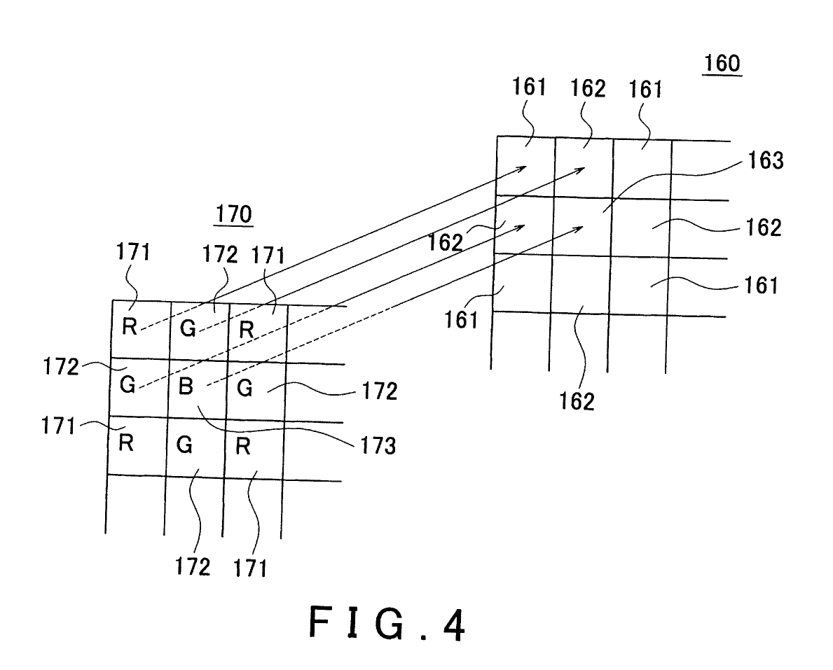

FIG. 4 shows an example of a correspondence between a color filter 170 and an image capturing element 160. The color filter 170 includes a plurality of R color filters 171, G color filters 172, and B filters 173. The light transmitted through an R color filter 171 is received by an R light receiving element 161 of the image capturing element 160. The light transmitted through a G color filter 172 is received by a G light receiving element 162 of the image capturing element 160. The light transmitted through a B color filter 173 is received by a B light receiving element 163 of the image capturing element 160. Light transmitted through one color filter is received by one light receiving element. In other words, the light transmitted through each of the R color filters 171 is received by a corresponding one of the R light receiving elements 161. The light transmitted through each of the G color filters 172 is received by a corresponding one of the G light receiving elements 162. The light transmitted through each of the B color filters 173 is received by a corresponding one of the B light receiving elements 163.

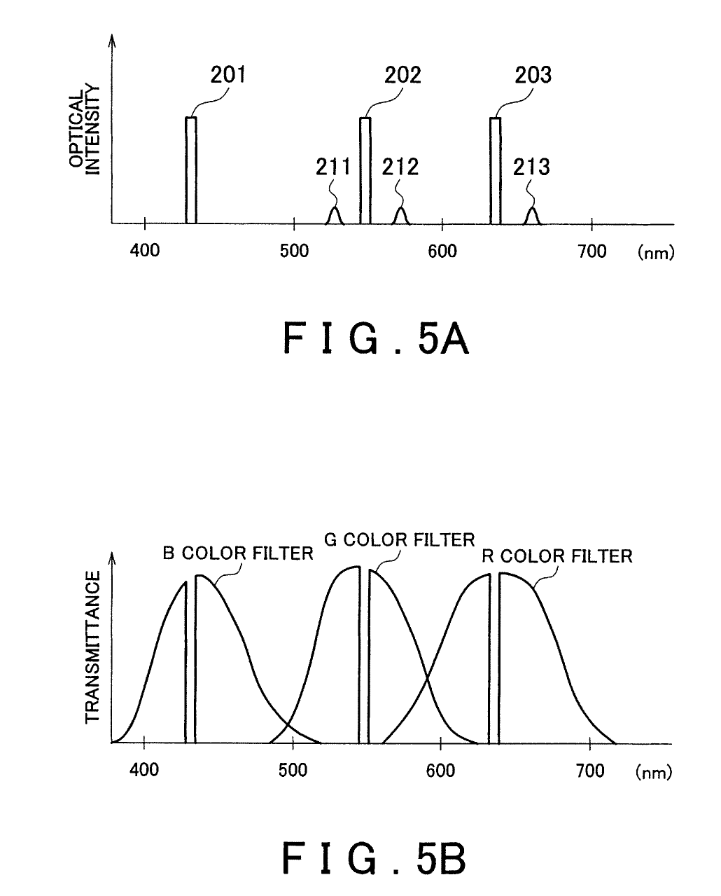

FIG. 5A shows an example of excitation light and wavelengths of fluorescent light excited by the excitation light. Excitation light 201 excites FAD, excitation light 202 excites Alexa Fluor (registered trademark) 555, and excitation light 203 excites Alexa Fluor (registered trademark) 647. That is, the filter 142 transmits the wavelength band of the excitation light 201. The filter 143 transmits the excitation light 202. The filter 144 transmits the excitation light 203. The fluorescent light 211 is self fluorescent light of FAD excited by means of the excitation light 201. The peak wavelength of the fluorescent light 211 is 525 nm. The fluorescent light 212 results from excitation of the excitation light 202. The peak wavelength of the excitation light 202 is 570 nm. The fluorescent light 213 results from excitation of the excitation light 203. The peak wavelength of the fluorescent light 203 is 660 nm.

FIG. 5B shows an example of a transmission characteristic of an R color filter 171, a G color filter 172, and a B color filter 173. An R color filter 171, a G color filter 172, and a B color filter 173 have overlapped transmission characteristics suited for color reproduction. An R color filter 171 principally transmits red light. In the present embodiment, the wavelength band of light transmitted through the R color filter 171 is referred to as a red wavelength band. The G color filter 172 principally transmits green light. In the present embodiment, the wavelength band of light transmitted through the G color filter 172 is referred to as a green wavelength band. The B color filter 173 principally transmits blue light. In the present embodiment, the wavelength band of light transmitted through the B color filter 173 is referred to as a blue wavelength band.

The R color filter 171 filters out the light of the wavelength band of the excitation light 203 from the light of the red wavelength band, thereby transmitting the light other than in the wavelength band of the excitation light 203. That is, the R color filter 171 transmits the light of the red wavelength band, excluding the light of the wavelength band of the excitation light 203, i.e. does not transmit the light of the wavelength band of the excitation light 203. The G color filter 172 filters out the light of the wavelength band of the excitation light 202 from the light of the green wavelength band, thereby transmitting the light other than in the wavelength band of the excitation light 202. That is, the G color filter 172 transmits the light of the green wavelength band, excluding the light of the wavelength band of the excitation light 202, i.e. does not transmit the light of the wavelength band of the excitation light 202. The B color filter 173 filters out the light of the wavelength band of the excitation light 201 from the light of the blue wavelength band, thereby transmitting the light other than in the wavelength band of the excitation light 201. That is, the B color filter 173 transmits the light of the blue wavelength band, excluding the light of the wavelength band of the excitation light 201, i.e. does not transmit the light of the wavelength band of the excitation light 201.

Any of the R color filter 171, the G color filter 172, and the B color filter 173 transmits fluorescent light 211 excited by the excitation light 201. Any of the R color filter 171, the G color filter 172, and the B color filter 173 transmits fluorescent light 212 excited by the excitation light 202. Any of the R color filter 171, the G color filter 172, and the B color filter 173 transmits fluorescent light 213 excited by the excitation light 203. Here, the G color filter 172 transmits the fluorescent light 211 and the fluorescent light 212. The R color filter 171 transmits the fluorescent light 213.

Accordingly, even when the irradiating section 106 emits the excitation light 201, the excitation light 201 is filtered out by the R color filter 171, the G color filter 172, and the B color filter, and so the excitation light 201 will not be captured by the image capturing element 160, and the G light receiving element 162 receives the fluorescent light 211 excited by the excitation light 201. In addition, even when the excitation light 202 is emitted, the excitation light 202 is filtered out by the R color filter 171, the G color filter 172, and the B color filter, and so the excitation light 202 will not be captured by the image capturing element 160, and the G light receiving element 162 receives the fluorescent light 212 excited by the excitation light 202. Even when the excitation light 203 is emitted, the excitation light 203 is filtered out by the R color filter 171, the G color filter 172, and the B color filter, and so the excitation light 203 will not be captured by the image capturing element 160, and the R light receiving element 161 receives the fluorescent light 213 excited by the excitation light 203.

The R color filter 171, the G color filter 172, and the B color filter 173 have a transmission characteristic filtering the wavelength band of the excitation light. Therefore, even when white light is emitted, the resulting color image is clear, without deteriorating the image quality. That is, a clear color image can be obtained because in principle, the R color filter 171 transmits a red wavelength band, the G color filter 172 transmits a green wavelength band, and the B color filter 173 transmits a blue wavelength band. A color filter may be designed to have a transmission characteristic filtering only the wavelength band of the excitation light included in the wavelength band transmitted through the color filter. For example, the R color filter 171 may have such a transmission characteristic as filtering out the light of the wavelength band of the excitation light 203, while transmitting the light of the red wavelength band.

Since the fluorescent light 211 is captured by a light receiving element different from the light receiving element capturing the fluorescent light 213, when the excitation light 201 is simultaneously emitted with the excitation light 203, the image of the fluorescent light 211 can be captured simultaneously with the image of the fluorescent light 213. That is, since the fluorescent light 211 is received by the G light receiving elements 162, the image of the fluorescent light 211 can be obtained from the charge accumulated in the G light receiving elements 162. In addition, since the fluorescent light 213 is received by the R light receiving elements 161, the image of the fluorescent light 213 can be obtained from the charge accumulated in the G light receiving elements 162.

Likewise, since the fluorescent light 212 is captured by a light receiving element different from the light receiving element capturing the fluorescent light 213, when the excitation light 202 is simultaneously emitted with the excitation light 203, the image of the fluorescent light 212 can be captured simultaneously with the image of the fluorescent light 213. In this case, the irradiating section 106 may emit two different rays of excitation light within an exposure time of the image capturing element 160, or a filter transmitting two different rays of excitation light may be used to simultaneously emit the two different rays of excitation light. In addition, it is preferable that fluorescent light be transmitted through only one of the R color filter 171, the G color filter 172, and the B color filter 173. In other words, it is preferable that the fluorescent light not have wavelengths within any wavelength bands where the transmission characteristics of the R color filter 171, the G color filter 172, and the B color filter 173 overlap with each other.

Next, the operation of the image capturing apparatus 100 is explained. When the mode switching section 110 switches to the normal image capturing mode, the irradiating section 106 rotates the rotation filter 109, to set the filter 141 for transmitting white light on the optical path, and irradiate the subject being an observation target with white light. Then, the returned light from the subject is received by the image capturing element 160 via the lens 131 and the color filter 170. That is, red light of the returned light is transmitted through the R color filter 171, to be received by the R light receiving element 161, and green light thereof is transmitted through the G color filter 172, to be received by the G light receiving element 162, and blue light thereof is transmitted through the B color filter 173, to be received by the B light receiving element 163. The image capturing element driver 180 reads the image captured by the image capturing element. Specifically, the image capturing driver 180 reads the charge accumulated in each light receiving element.

The visible light image generating section 102 generates a visible light image of the subject from the read image. Specifically, the visible light image generating section 102 generates a color image of the subject from the read image. The visible light image generating section 102 may generate an image of a luminance/color difference signal from the read image. The display section 104 may display the visible light image generated by the visible light image generating section 102. The recording section 105 may record the visible light image generated by the visible light image generating section 102.

When the mode switching section 110 switches to the fluorescent light image capturing mode, the irradiating section 106 rotates the rotation filter 109, to set, on the optical path, any of the filter 142, the filter 143, and the filter 144 for transmitting excitation light, and irradiate the subject being an observation target with excitation light. When the excitation light 203 is emitted by setting the filter 144 on the optical path, the returned light of the excitation light 203 from the subject and the fluorescent light 213 excited by the excitation light are incident on the color filter 170 via the lens 131. In this case, Alexa Fluor (registered trademark) 647 is assumed to have been scattered on the surface of the subject being the observation target. Since the R color filter 171 of the color filter 170 filters out the excitation light 203, the image capturing element 160 captures only the fluorescent light 213. Specifically, the R light receiving element 161 receiving the light transmitted through the R color filter 171 receives the fluorescent light 213.

When the irradiating section 106 irradiates the subject with the excitation light 202, the returned light of the excitation light 202 and the fluorescent light 212 excited by the excitation light are incident on the color filter 170 via the lens 131. In this case, Alexa Fluor (registered trademark) 555 is assumed to have been scattered on the surface of the subject. Since the G color filter 172 of the color filter 170 filters out the excitation light 202, the image capturing element 160 captures only the fluorescent light 212. Specifically, the G light receiving element 162 receiving the light transmitted through the G color filter 172 receives the fluorescent light 212.

When the irradiating section 106 irradiates the subject with the excitation light 201, the returned light of the excitation light 201 and the fluorescent light 211 excited by the excitation light are incident on the color filter 170 via the lens 131. In this case, Alexa Fluor (registered trademark) 555 or the like may not be provided on the surface of the subject, because the fluorescent light 211 is a self fluorescent substance. Since the B color filter 173 of the color filter 170 filters out the excitation light 201, the image capturing element 160 captures only the fluorescent light 211. Specifically, the G light receiving element 162 receiving the light transmitted through the G color filter 172 receives the fluorescent light 211.

The image capturing element driver 180 may add together the charge accumulated in the light receiving elements having received the fluorescent light, when reading. By doing so, the sensitivity of the light receiving elements receiving the fluorescent light improves. When the image capturing element 160 is a CMOS, the reading may be performed by adding together only the charge accumulated in the light receiving elements having received the fluorescent light. When the light receiving elements to receive the fluorescent light are known in advance, the sensitivity of the light receiving elements may be set higher than the sensitivity of the other light receiving elements that are not to receive the fluorescent light. The fluorescent light image generating section 103 generates a fluorescent light image of a subject, from the read image. Specifically, the fluorescent light image is generated from the charge accumulated in the light receiving elements having added together and read out. The display section 104 may display the fluorescent light image generated by the fluorescent light image generating section 103, and the recording section 105 may record the fluorescent light image generated by the fluorescent light image generating section 103.

In this way, each one of the R color filters 171, the G color filters 172, and the B color filters 173 of the color filter 170 is designed to respectively transmit light of a corresponding one of the red wavelength band, the green wavelength band, and the blue wavelength band, as well as filtering out the wavelength band of excitation light. Therefore, a single color filter 170 can capture both of a fluorescent light image and a visible light image. In addition, an additional excitation light cutting filter is unnecessary, which prevents deterioration of the image quality of the resulting color images, and helps prevent additional cost. That is, since excitation light is in a narrow band, even when the wavelength band of the excitation light is filtered out, the RGB balance is not affected, and a clear color image can be captured. In addition, the sensitivity is improved by adding together the charge accumulated in the light receiving elements having received the fluorescent light, a clear image can be captured even with fluorescent light having weak optical intensity. Note that an information processing apparatus such as a CPU can be designed to function as the image capturing apparatus 100 by execution of a predetermined program.

The following are possible modification examples.

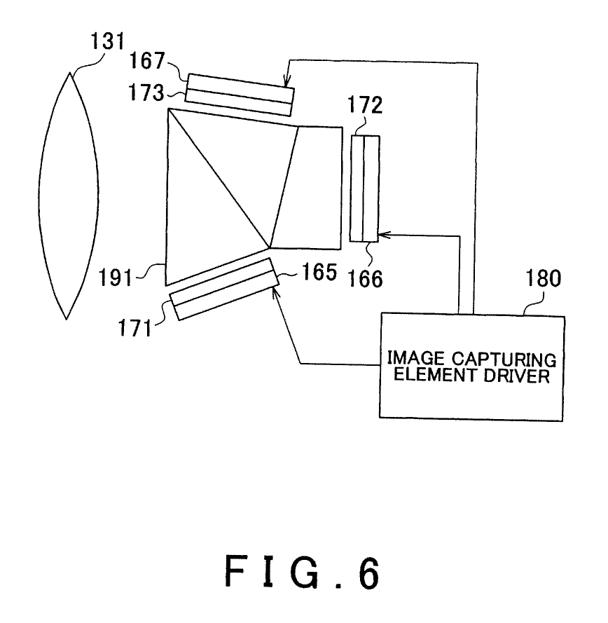

(1) Although the above-described embodiment uses a single plate system, a three plate system may also be used. FIG. 6 shows an example of an image capturing section 112 of an image capturing apparatus 100 according to the present modification example 1. The image capturing section 112 includes a lens 131, a light splitter 191, an R color filter 171, a G color filter 172, a B color filter 173, an R image capturing element 165, a G image capturing element 166m a B image capturing element 167, and an image capturing element driver 180.

The light splitter 191 splits the light incident via the lens 131 into three light fluxes. The three light fluxes spit by the light splitter 191 are respectively incident to the R color filter 171, the G color filter 172, and the B color filter 173. The R image capturing element 165 captures an image of light transmitted through the R color filter 171.

The G image capturing element 166 captures an image of light transmitted through the G color filter 172. The B image capturing element 167 captures an image of light transmitted through the B color filter 173. Here, the R color filter 171 transmits the red wavelength band except for the excitation light by filtering out the excitation light 203 contained in the red wavelength band, as shown in FIG. 5A and FIG. 5B. Consequently, even the excitation light 203 is emitted, the excitation light 203 will not be captured by the R image capturing element 165. Likewise, the G color filter 172 transmits the green wavelength band except for the excitation light by filtering out the excitation light 202 contained in the green wavelength band. Consequently, even the excitation light 202 is emitted, the excitation light 202 will not be captured by the G image capturing element 166. Likewise, the B color filter 173 transmits the blue wavelength band except for the excitation light by filtering out the excitation light 201 contained in the blue wavelength band. Consequently, even the excitation light 201 is emitted, the excitation light 201 will not be captured by the B image capturing element 167.

In the normal image capturing mode, the image capturing element driver 180 reads the images respectively captured by the R image capturing element 165, the G image capturing element 166, and the B image capturing element 167. That is, the image capturing element driver 180 reads the charge accumulated in each light receiving element of the R image capturing element 165. The image capturing element driver 180 also reads the charge accumulated in each light receiving element of the G image capturing element 166. The image capturing element driver 180 also reads the charge accumulated in each light receiving element of the B image capturing element 167. The read images will be outputted to the visible light image generating section 102. The operations hereafter are the same as those in the above-described embodiment, and so are not explained below.

In the fluorescent image capturing mode, the image capturing element driver 180 may read only the charge accumulated in the image capturing element having captured fluorescent light. For example, when the excitation light 203 is emitted, the image capturing element driver 180 may read the charge accumulated in each light receiving element of the R image capturing element 165. When reading, the image capturing element driver 180 may add together the charge accumulated in the light receiving elements having captured fluorescent light. In other words, the image capturing element driver 180 may add together the charge accumulated in the light receiving elements of the image capturing element having captured the fluorescent light, when reading it. When the light receiving elements to receive the fluorescent light are known in advance, the sensitivity of the light receiving elements may be set higher than the sensitivity of the other light receiving elements that are not to receive the fluorescent light. The read images are outputted to the fluorescent light image generating section 103. The operations hereafter are the same as those in the above-described embodiment, and so are not explained below.

(2) In the above-described embodiment, the irradiating section 106 is designed to emit three types of excitation light. However, two types of excitation light, or four or more types of excitation light may be adopted.

(3) In the above-described embodiment, the irradiating section 106 is designed to emit the excitation light 201 exciting FAD, the excitation light 202 exciting Alexa Fluor (registered trademark) 555, and the excitation light 203 exciting Alexa Fluor (registered trademark) 647. However, the excitation light used in irradiation is not limited to them. In addition, it is sufficient that one of the R color filter 171, the G color filter 172, and the B color filter 173, which transmits the wavelength band including the excitation light to be emitted have a transmission characteristic of filtering out the wavelength band of the excitation light. One of the R color filter 171, the G color filter 172, and the B color filter 173 may be designed to transmit fluorescent light excited by the excitation light 203. It is also possible to use a fluorochrome whose fluorescent light is transmitted through one of the R color filter 171, the G color filter 172, and the B color filter 173.

(4) The irradiating section 106 has been described to independently emit the rays of excitation light respectively of the color wavelength bands. However, only the rays of excitation light of two color wavelength bands may be independently emitted. That is, only the rays of excitation light respectively of two of the color wavelength bands of the red wavelength band, the green wavelength band, and the blue wavelength band may be emitted. For example, the irradiating section 106 may emit the excitation light of the red wavelength band and the excitation light of the green wavelength band. The irradiating section 106 may emit the excitation light of the red wavelength band and the excitation light of the blue wavelength band. Moreover, only the excitation light of one of the color wavelength bands may be emitted. In this case, the color filter transmitting the light of the wavelength band including the excitation light emitted from the irradiating section 106 is to have the transmission characteristic of filtering out the excitation light. For example, when the G color filter 172 transmits the excitation light emitted from the irradiating section 106, the G color filter 172 has the transmission characteristic of filtering out the excitation light.

(5) In addition, any of the above-described modification examples (1)-(4) may be combined together.

Although some aspects of the present invention have been described by way of exemplary embodiments, it should be understood that those skilled in the art might make many changes and substitutions without departing from the spirit and the scope of the present invention which is defined only by the appended claims.

The operations, the processes, the steps, or the like in the apparatus, the system, the program, and the method described in the claims, the specification, and the drawings are not necessarily performed in the described order. The operations, the processes, the steps, or the like can be performed in an arbitrary order, unless the output of the former-described processing is used in the later processing. Even when expressions such as “First,” or “Next,” or the like are used to explain the operational flow in the claims, the specification, or the drawings, they are intended to facilitate the understanding of the invention, and are never intended to show that the described order is mandatory.

What is claimed is:

1. An image capturing apparatus for capturing a fluorescent light image from a subject irradiated with first excitation light or second excitation light, comprising:
a first filter that transmits remaining light of a first wavelength band after filtering out, from the light of the first wavelength band, a wavelength band of the first excitation light;
a first light receiving element that receives the light transmitted through the first filter;
a second filter that transmits remaining light of a second wavelength band after filtering out, from the light of the second wavelength band, a wavelength band of the second excitation light; and
a second light receiving element that receives the light transmitted through the second filter.

2. The image capturing apparatus according to claim 1, further comprising:
a third filter that transmits light of a third wavelength band that is different from the first wavelength band and the second wavelength band; and
a third light receiving element that receives light transmitted through the third filter, wherein
the first wavelength band, the second wavelength band, and the third wavelength band are a red wavelength band, a green wavelength band, and a blue wavelength band, respectively.

3. The image capturing apparatus according to claim 2, further comprising:
an image generating section that generates an image of the subject, from light received by one or more of the first light receiving element, the second light receiving element, and the third light receiving element.

4. The image capturing apparatus according to claim 3, wherein
the image generating section includes:
a visible light image generating section that generates a visible light image of the subject irradiated with visible light belonging to the first wavelength band, the second wavelength band, and the third wavelength band, from the light received by the first light receiving element, the light received by the second light receiving element, and the light received by the third light receiving element.

5. The image capturing apparatus according to claim 4, wherein
the image generating section further includes:
a fluorescent light image generating section that generates the fluorescent light image of the subject irradiated with the first excitation light or the second excitation light, from light received by at least one of the first light receiving element, the second light receiving element, and the third light receiving element.

6. The image capturing apparatus according to claim 2, wherein
the image capturing apparatus has a) a normal image capturing mode for capturing a visible light image of the subject by irradiating the subject with visible light belonging to the first wavelength band, the second wavelength band, and the third wavelength band, and b) a fluorescent light image capturing mode for capturing the fluorescent light image of the subject by irradiating the subject with the first excitation light or the second excitation light, and
the image capturing apparatus further comprises:
a visible light image generating section that generates the visible light image of the subject, from light received by the first light receiving element, light received by the second light receiving element, and light received by the third light receiving element, in the normal image capturing mode; and
a fluorescent light image generating section that generates the fluorescent light image of the subject, from light received by at least one of the first light receiving element, the second light receiving element, and the third light receiving element, in the fluorescent light image capturing mode.

7. The image capturing apparatus according to claim 6, further comprising:
an irradiating section that irradiates the subject with the visible light in the normal image capturing mode, and irradiates the subject with the first excitation light or the second excitation light in the fluorescent light image capturing mode.

8. The image capturing apparatus according to claim 7, further comprising:
a mode switching section that switches between the normal image capturing mode and the fluorescent light image capturing mode.

9. The image capturing apparatus according to claim 2, wherein
at least one of the first filter, the second filter, and the third filter transmits fluorescent light from the subject irradiated with the first excitation light.

10. The image capturing apparatus according to claim 2, wherein
at least one of the first filter, the second filter, and the third filter transmits fluorescent light from the subject irradiated with the second excitation light.

11. The image capturing apparatus according to claim 10, wherein
at least one of the first light receiving element, the second light receiving element, and the third light receiving element that receives the fluorescent light from the subject is more sensitive than the light receiving elements not receiving the fluorescent light from the subject.

12. The image capturing apparatus according to claim 10, further comprising:
an image capturing element in which first light receiving elements, second light receiving elements, and third light receiving elements are arranged in a plane; and
an image capturing element driver that drives the image capturing element, wherein
the image capturing element driver adds up charge accumulated in a plurality of light receiving elements that receive the fluorescent light from the subject before reading the accumulated charge, the plurality of light receiving elements being among the first light receiving elements, the second light receiving elements, and the third light receiving elements.

13. The image capturing apparatus according to claim 10, further comprising:
a light splitter that splits the fluorescent light from the subject into three, and supplies the split light respectively to the first filter, the second filter, and the third filter;
a first image capturing element in which first light receiving elements are arranged to receive the light transmitted through the first filter;
a second image capturing element in which second light receiving elements are arranged to receive the light transmitted through the second filter;
a third image capturing element in which third light receiving elements are arranged to receive the light transmitted through the third filter; and
an image capturing element driver that drives the first image capturing element, the second image capturing element, and the third image capturing element, wherein
the image capturing element driver adds up charge accumulated in a plurality of light receiving elements that receive the fluorescent light from the subject, before reading the accumulated charge, the plurality of light receiving elements being among the first light receiving elements, the second light receiving elements, and the third light receiving elements.

14. The image capturing apparatus according to claim 1, being an endoscope apparatus, wherein
a tip of an insertion section of the endoscope apparatus is provided with the first filter, the second filter, the first light receiving element, and the second light receiving element.
